(19) United States
(12) Patent Application Publication
(10) Pub. No.: US 2007/0198524 A1
(43) Pub. Date: Aug. 23, 2007

(54) Maintaining connections between application servers and databases in a multitier computer architecture

(75) Inventors: Steven J. Branda, Rochester, MN (US); John J. Stecher, Rochester, MN (US)

Correspondence Address: IBM (ROC-BLF), C/O BIGGERS & OHANIAN, LLP, P.O. BOX 1469, AUSTIN, TX, 78767-1469, US

(73) Assignee: International Business Machines Corporation, Armonk, NY (US)

(21) Appl. No.: 11/351,238

(22) Filed: Feb. 9, 2006

(51) Int. Cl. G06F 17/30

(52) U.S. Cl. 707/10

(57) ABSTRACT

Maintaining connections between application servers and databases in a multitier computer architecture, including providing, through a highly available connection proxy, connections between application servers and databases, where the highly available connection proxy implements a single call point for providing the connections; monitoring by the highly available connection proxy connected databases for database failures; and replacing by the highly available connection proxy a connection to a failing database with a connection to a replica of the failing database.

### BACKGROUND OF THE INVENTION

1. Field of the Invention

The field of the invention is data processing, or, more specifically, methods, apparatus, and products for maintaining connections between application servers and databases in a multitier computer architecture.

2. Description of Related Art

The development of the EDVAC computer system of 1948 is often cited as the beginning of the computer era. Since that time, computer systems have evolved into extremely complicated devices. Today's computers are much more sophisticated than early systems such as the EDVAC. Computer systems typically include a combination of hardware and software components, application programs, operating systems, processors, buses, memory, input/output devices, and so on. As advances in semiconductor processing and computer architecture push the performance of the computer higher and higher, more sophisticated computer software has evolved to take advantage of the higher performance of the hardware, resulting in computer systems today that are much more powerful than just a few years ago.

One of the fields of computer technology that has seen rapid development is scalable computer architectures. Architectures have advanced from a single, central mainframe, to mainframes with dumb terminals, to client-server architectures, to multitier architectures implemented with middleware application servers connecting clients to databases. One of the major problems with current middleware application servers is that if a database goes down for any reason, either a failure or just a planned reboot, the application running on the application server will experience some sort of error condition which, in most cases, will be visible to all clients coming to the site in the time of the database outage. In most cases when the database goes down, the database connection the application is currently using throws an exception that indicates the database is down which, in most cases, the user application is forced to handle as an application-level error (requiring specific handcrafted code which can be different for each application server). Alternatively, the application can ignore the error and just allow it to cause the user's transaction to roll back, forcing the user to resubmit the transaction; which is very undesirable in most cases as it leads to clients becoming frustrated with the web application, possibly even abandoning the application and moving to an alternative one. There is therefore an ongoing need or improvement in maintaining connections between application servers and databases in multitier computer architectures.

### SUMMARY OF THE INVENTION

Methods, apparatus, and computer program products are disclosed for maintaining connections between application servers and databases in a multitier computer architecture that include providing, through a highly available connection proxy, connections between application servers and databases, where the highly available connection proxy implements a single call point for providing the connections; monitoring by the highly available connection proxy connected databases for database failures; and replacing by the highly available connection proxy a connection to a failing database with a connection to a replica of the failing database.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 sets forth a network diagram illustrating an exemplary system for maintaining connections between application servers and databases in a multitier computer architecture according to embodiments of the present invention.

FIG. 2 sets forth a network diagram illustrating a further exemplary system for maintaining connections between application servers and databases in a multitier computer architecture according to embodiments of the present invention.

FIG. 3 sets forth a block diagram of automated computing machinery comprising an exemplary computer useful in maintaining connections between application servers and databases in a multitier computer architecture according to embodiments of the present invention.

FIG. 4 sets forth a functional block diagram of an exemplary system for maintaining connections between application servers and databases in a multitier computer architecture according to embodiments of the present invention.

FIG. 5 sets forth a functional block diagram of a further exemplary system for maintaining connections between application servers and databases in a multitier computer architecture according to embodiments of the present invention.

FIG. 6 sets forth a class relationship diagram illustrating an exemplary wrapper for a connection useful in maintaining connections between application servers and databases in a multitier computer architecture according to embodiments of the present invention.

FIG. 7 sets forth a flow chart illustrating an exemplary method for maintaining connections between application servers and databases in a multitier computer architecture according to embodiments of the present invention.

FIG. 8 sets forth a flow chart illustrating a further exemplary method for maintaining connections between application servers and databases in a multitier computer architecture according to embodiments of the present invention.

### DETAILED DESCRIPTION OF EXEMPLARY EMBODIMENTS

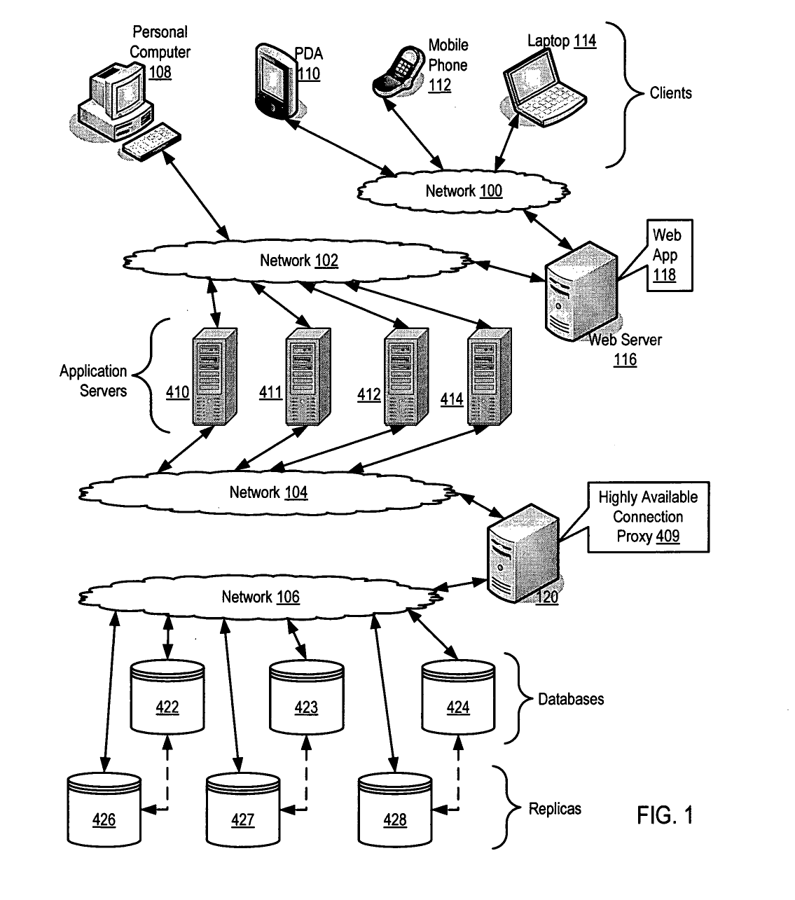

Exemplary methods, apparatus, and products for maintaining connections between application servers and databases in a multitier computer architecture according to embodiments of the present invention are described with reference to the accompanying drawings, beginning with FIG. 1. FIG. 1 sets forth a network diagram illustrating an exemplary system for maintaining connections between application servers and databases in a multitier computer architecture according to embodiments of the present invention.

The system of FIG. 1 implements a multitier computer architecture. A multitier architecture is a client-server architecture in which an application is executed by more than one distinct software agent. The most widespread use of “multi-tier architecture” refers to three-tier architecture. The system of FIG. 1 implements three tiers as:
a client tier (108, 110, 112, 114) that presents user interfaces to users,
a functional process logic tier that implements ‘business rules’—represented here by application servers (410, 411, 412, 414), and
a data storage tier represented here by databases (422, 423, 424) and their replicas (426, 427, 428).

In this example, the client tier include personal computer (108), which connects to applications servers through network (102). The client tier includes personal digital assistant (110), mobile phone (112), and laptop computer (114), all of which connect to application servers through network (100), web server (116), and network (102).

Web server (116) running web application (118) effectively adds a fourth tier to the architecture of the system of FIG. 1. Web application (118) provides calling points for requests from thin clients, web browsers or microbrowsers running on clients (110, 112, 114), and then forwards such requests to other enterprise servers, in particular, application components on application servers (410, 411, 412, 414). In addition, application servers like the ones illustrated here typically also implement a layer of middleware (not shown on FIG. 1) for accessing data in the data storage tier that may be considered a fifth tier of a multitier architecture.

An ‘application server,’ as the term is used here, is a server computer in a multitier computer architecture dedicated to running certain software applications. The term also may refer, depending on context, to the software installed on such a computer to facilitate the serving (running) of other applications. Following the success of the Java™ platform, the term application server often refers to a Java 2 Platform, Enterprise Edition™, or ‘J2EE’ application server. IBM's WebSphere™ and BEA's WebLogic™ are the better known commercial J2EE application servers. The JOnAS™ application server, developed by the ObjectWeb consortium, is a non commercial, open source application server having official certification of compliance with J2EE. As mentioned, the most common language for these big operations is Java. The web application modules typically are servlets and JavaServer Pages (‘JSPs’), and the business logic is built into Enterprise JavaBeans (‘EJBs’) and the J2EE platform provides standards for containing the components of web applications. Tomcat™ from Apache and JOnAS from ObjectWeb are typical of containers for web applications.

Servlets are Java programs that execute in a Web container and are the equivalent of Common Gateway Interface (‘CGI’) scripts. JSP is a way to create HTML pages by embedding the server logic within the page by using references so as not to clutter it. HTML coders and Java programmers can work side by side by referencing each other's code within their own. JavaBeans are the independent class components of the Java2 architecture from Sun Microsystems.

The term application server has also been applied to various non-J2EE and non-Java offerings. For example, with the rising popularity of .NET™, Microsoft can claim to deliver an application server. There are also other open source and commercial application servers from vendors. Some examples are the Base4 Server™ and Zope™.

Application server products typically bundle middleware to enable applications to intercommunicate with various qualities of service—reliability, security, non-repudiation, and so on. Application servers also provide an Application Programming Interface (‘API’) to programmers, so programmers need not be concerned with the operating system or the huge array of interfaces required of a modern web based application. There has to be communication with the web in the form of HTML and XML, links to various kinds of databases, and very likely links to systems and devices ranging from huge and irreplaceable legacy applications to small information devices which could be a link to the atomic clock or even home appliances.

A ‘database,’ as the term is used here, is a collection of information stored in a computer in a systematic way, so that a computer program can consult the information in the database to answer questions or respond to queries about the information. The database application software used to manage and query a database is known as a database management system (‘DBMS’). ‘Middleware’ is software that provides applications on application servers connections to databases and programmatic access to databases and their DBMSs.

The system of FIG. 1 also includes a highly available connection proxy installed in this example on a separate server (120). The system of FIG. 1 operates generally to maintaining connections between application servers and databases according to embodiments of the present invention by providing, through highly available connection proxy (409), connections between application servers (410, 411, 412, 414) and databases (422, 423, 424). In the example of FIG. 1, highly available connection proxy (409) is a software module installed on its own server (120) that provides connections between application servers and databases through networks (104, 106). The highly available connection proxy (409) implements a single call point for providing the connections. The highly available connection proxy (409) also monitors connected databases (422, 423, 424) for database failures replaces a connection to a failing database with a connection to a replica of the failing database. The system of FIG. 1 includes a replica (426, 427, 428) for each database (422, 423, 424) of the system.

In this example, highly available connection proxy (409) and its server (120) represent the only data communications pathway between networks (104, 106), so that all database commands or requests for data from the application servers must go through the proxy (409). The illustrated architecture, however, is not a limitation of the present invention. Alternatively, for example, networks (104, 106) may be the same network, and highly available connection proxy (409) may provide connections that allow applications servers to communicate directly with databases—rather than passing all database commands through the proxy (409).

Examples in this specification may tend to be expressed in terms of Java—because of the predominance of J2EE for multitier computer architectures. In a J2EE environment, the ‘connections’ between application servers and databases provided by a highly available connection proxy according to embodiments of the present invention typically are Java DataBase Connectivity (‘JDBC’) connections or J2EE Connector Architecture (‘JCA’) connections. In an environment that supports many applications in C and C++, the connections may be Open Database Connectivity (‘ODBC’) connections. In an environment that supports applications in Microsoft's Visual Basic™, the connections may be ActiveX Data Object (‘ADO’) connections. In an environment that supports applications in Microsoft's .NET languages, C#, J#, and the like, the connections may be ADO.NET connections. Connections for maintaining connections between application servers and databases according to embodiments of the present invention may be implemented not only with J2EE connection technology, but with any connection technology as may occur to those of skill in the art.

The arrangement of servers and other devices making up the exemplary system illustrated in FIG. 1 are for explanation, not for limitation. Data processing systems useful according to various embodiments of the present invention may include additional servers, routers, other devices, and peer-to-peer architectures, not shown in FIG. 1, as will occur to those of skill in the art. Networks in such data processing systems may implemented as intranets, extranets, wide area networks, local area networks, and so on. Networks in such data processing systems may support many data communications protocols, including for example Transmission Control Protocol (‘TCP’), Internet Protocol (‘IP’), HyperText Transfer Protocol (‘HTTP’), Wireless Access Protocol (‘WAP’), Handheld Device Transport Protocol (‘HDTP’), and others as will occur to those of skill in the art. Various embodiments of the present invention may be implemented on a variety of hardware platforms in addition to those illustrated in FIG. 1.

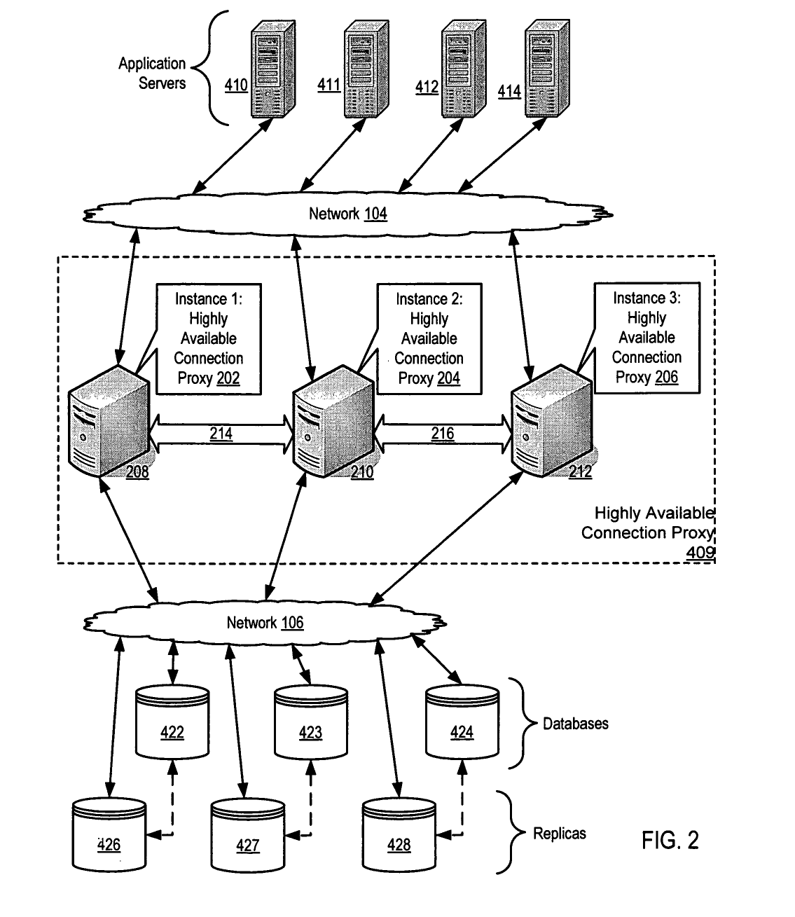

FIG. 2 sets forth a network diagram illustrating a further exemplary system for maintaining connections between application servers and databases in a multitier computer architecture according to embodiments of the present invention. FIG. 2 includes an implementation of a highly available connection proxy (409). Highly available connection proxy (409) provides connections between application servers and databases as described above with respect to the system of FIG. 1 and as described in even more detail below in this specification. Highly available connection proxy (409) in the example of FIG. 2 is made highly available by including in the system several instances (202, 204, 206) of a connection proxy on several separate server computers (208, 210, 212).

In the example of FIG. 2 the highly available connection proxy is implemented by a plurality of proxy computers, the server computers (208, 210, 212), each communicating (214, 216) its status to the others. High availability in the system of FIG. 2, for example, may be achieved by programming the instances of the highly available connection proxy to detect and report a failure of any instance of the highly available connection proxy so that the failing instance may be replaced before another fails. Instances of the proxy may communicate status with one another (214, 216) by maintaining heartbeat signals among the instances, and a failure to receive a heartbeat signal from an instance through a preset time period, for example, may be taken as a failure of that instance.

In the system of FIG. 2, a router of network (104) may be programmed to broadcast all network communications equally to all instances (202, 204, 206) of the proxy. The instances of the proxy, that is, the proxy computers (208, 210, 212), may then determine according to an algorithm which proxy computer (or instance of the proxy) is to respond to current requests for connections. By broadcasting all connection requests to all instances of the proxy and determining among the proxies which is to respond to current requests, the highly available connection proxy (409) taken as a whole, continues to implement for the application servers a single call point for providing the connections. Here are example algorithms by which instances of the proxy may determine which proxy computer is to respond to current requests from application servers for connections to databases:
For instance 1: Respond to all connection requests. (This algorithm will not be executed if instance 1 fails.)
For instance 2: Upon receiving a connection request, do nothing if instance 1 has not failed. If instance 1 has failed, respond to all connection requests until instance 1 is restored. (Not executed if instance 2 has failed.)
For instance 3: Upon receiving a connection request, do nothing if either instance 1 or instance 2 has not failed. If both instance 1 and instance 2 have failed, respond to all connection requests until instance 1 or instance 2 is restored.

To synchronize the status of all instances of the proxy, whichever instance actually responds to a connection request may mirror its actions to the other instances of the proxy. Then, whether the instances are programmed to retain callback references or to retain the connections themselves (providing wrappers to represent the connections in the application servers), all active instances of the proxy will be in the same exact condition. When one instance fails, all other instances are already prepared to take over.

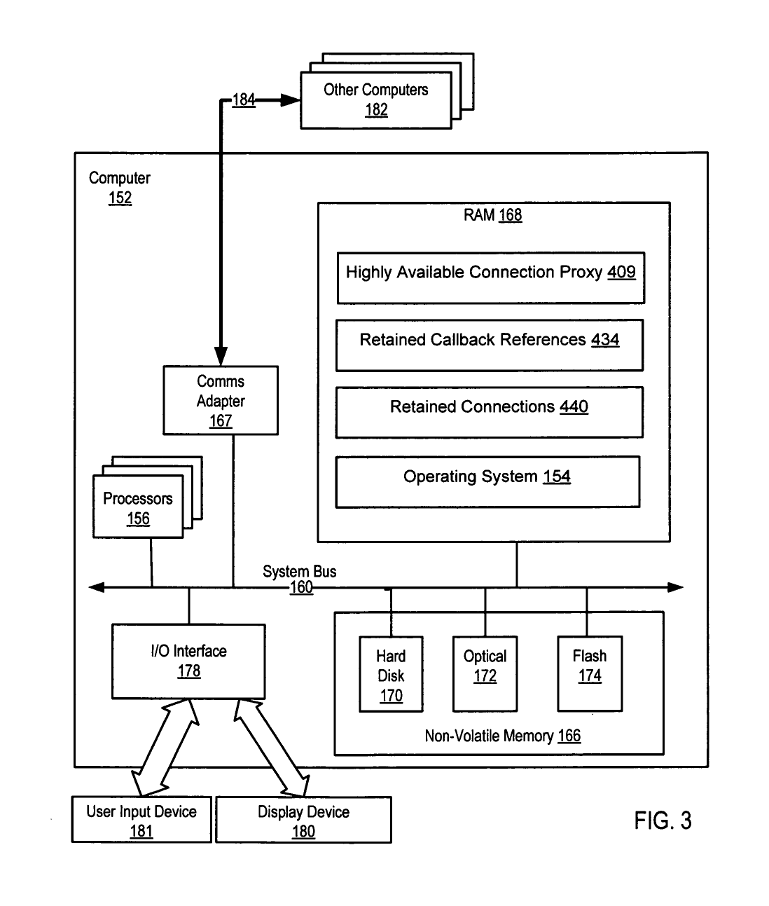

Maintaining connections between application servers and databases in a multitier computer architecture in accordance with the present invention is generally implemented with computers, that is, with automated computing machinery. In the systems of FIGS. 1 and 2, for example, all the databases, servers, and networks are implemented to some extent at least as computers. For further explanation, therefore, FIG. 3 sets forth a block diagram of automated computing machinery comprising an exemplary computer (152) useful in maintaining connections between application servers and databases in a multitier computer architecture according to embodiments of the present invention. The computer (152) of FIG. 3 includes at least one computer processor (156) or ‘CPU’ as well as random access memory (168) (‘RAM’) which is connected through a system bus (160) to processor (156) and to other components of the computer.

Stored in RAM (168) is a highly available connection proxy (409), computer program instructions for maintaining connections between application servers and databases in a multitier computer architecture. Highly available connection proxy (409) is programmed to provide connections between application servers and databases, including implementing a single call point for providing the connections. The highly available connection proxy (409) is also programmed to monitor connected databases for database failures and to replace a connection to a failing database with a connection to a replica of the failing database.

Also stored RAM (168) are retained callback references (434) and retained connections (440). Highly available connection proxy (409) may be programmed according to embodiments of the present invention to provide connections by returning each connection from the proxy to an application server that requested the connection and retain in the proxy a callback reference to each connection. Highly available connection proxy (409) may then also be programmed to replace a connection by notifying an application server of a failing database through a retained callback reference to the connection to the failing database.

Also stored RAM (168) are retained connections (440). Highly available connection proxy (409) may be programmed according to embodiments of the present invention to provide connections by retaining the connections in the proxy and providing to the application servers wrappers for the connections retained on the proxy. The wrappers then represent the connections in the application servers, and the wrappers contain references to the actual connections represented by the wrapper. Highly available connection proxy (409) may then also be programmed to replace a connection by replacing the connection in the proxy, that is, for example, by replacing in a wrapper a reference to a connection to a failing database with a reference to a connection to a replica of the failing database. When the proxy retains the actual connections, all database commands issued by application servers through the wrappers also pass through the proxy. In this case, highly available connection proxy (409) may then also be programmed to broadcast the database commands from application servers through the proxy to replica databases, proving a convenient way to update and synchronize all replicas with their respective original databases.

Also stored in RAM (168) is an operating system (154). Operating systems useful in computers according to embodiments of the present invention include UNIX™, Linux™, Microsoft NT™, AIX™, IBM's i5/OS™, and others as will occur to those of skill in the art. Operating system (154), highly available connection proxy (409) may then also be programmed, retained callback references (434), and retained connections (440) in the example of FIG. 3 are shown in RAM (168), but many components of such software typically are stored in non-volatile memory (166) also.

Computer (152) of FIG. 3 includes non-volatile computer memory (166) coupled through a system bus (160) to processor (156) and to other components of the computer (152). Non-volatile computer memory (166) may be implemented as a hard disk drive (170), optical disk drive (172), electrically erasable programmable read-only memory space (so-called ‘EEPROM’ or ‘Flash’ memory) (174), RAM drives (not shown), or as any other kind of computer memory as will occur to those of skill in the art.

The example computer of FIG. 3 includes one or more input/output interface adapters (178). Input/output interface adapters in computers implement user-oriented input/output through, for example, software drivers and computer hardware for controlling output to display devices (180) such as computer display screens, as well as user input from user input devices (181) such as keyboards and mice.

The exemplary computer (152) of FIG. 3 includes a communications adapter (167) for implementing data communications (184) with other computers (182), including, for example, application servers and databases. Such data communications may be carried out serially through RS-232 connections, through external buses such as a Universal Serial Bus (‘USB’), through data communications networks such as TCP/IP networks, and in other ways as will occur to those of skill in the art. Communications adapters implement the hardware level of data communications through which one computer sends data communications to another computer, directly or through a network. Examples of communications adapters useful for maintaining connections between application servers and databases in a multitier computer architecture according to embodiments of the present invention include modems for wired dial-up communications, Ethernet (IEEE 802.3) adapters for wired network communications, and 802.11b adapters for wireless network communications.

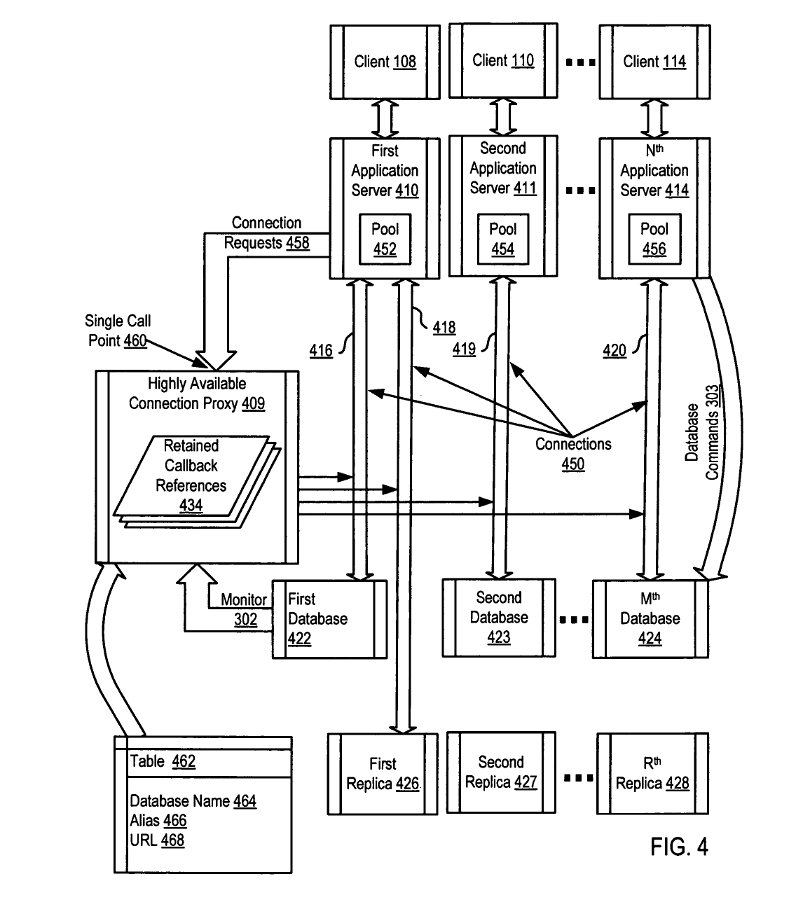

For further explanation, FIG. 4 sets forth a functional block diagram of an exemplary system for maintaining connections between application servers and databases in a multitier computer architecture according to embodiments of the present invention. The system of FIG. 4 includes several client devices (108, 110, 114), the exact number of which is not specified. The system of FIG. 4 also includes N application servers (410, 411, 414), where N can be any number. The system of FIG. 4 also includes M databases (422, 423, 424), where M can be any number. The system of FIG. 4 also includes R replicas (426, 427, 428) of the databases (422, 423, 424), where R can be any number. In typical systems for system for maintaining connections between application servers and databases in a multitier computer architecture according to embodiments of the present invention, R will be at least equal to M, but this description is for explanation only, not a limitation of the invention. If R is at least equal to M, each database may have at least one replica. If R is less than M, some databases are not replicated; if R is greater than M, some databases may have more than one replica. In this example, each replica is maintained as a replica of an operating database by traditional mirroring/journaling/backup technology.

In the system of FIG. 4, highly available connection proxy (409) provides connections (416, 419, 420) between application servers (410, 411-414) and databases (422, 423-424). Highly available connection proxy (409) implements a single call point (460) for providing the connections. Whereas in prior art, a separate call point or network address along with a database's name would be provided for each database, in this example, only a single network address is provided for each database. That is, in providing connections, highly available connection proxy (409) lists in the application servers a network address for the proxy as the network address for each database. In this example, each application server is deployed and configured with a list of needed database connections modified so that each application server lists the same IP address or URL for all database names, that is, the network address of the proxy, which in prior art would be the network address or URL of each DBMS of a database that needs to connect to the application server.

In fact, it is the implementation of the single call point (460) that makes highly available connection proxy (409) a ‘proxy.’ A reference to highly available connection proxy (409) replaces whatever class or object would traditionally be called by a pool or application server to obtain a connection to a database. In the example of J2EE, a reference to highly available connection proxy (409) replaces the reference in the object oriented Java framework of the application server to whatever JDBC object or service would traditionally be called to obtain a connection to a database, and it is in this sense that highly available connection proxy (409) is referred to as a ‘proxy.’

In a J2EE environment, such a list of database URLs and database names would be in an XML configuration file named in Websphere, for example, ‘resources.xml,’ a configuration file that is available to the application server at its startup time. In a J2EE environment, for example, the application server considers a ‘database’ the JDBC object representing a database, coupling the application server to the database with network address or URL for the database and a database name, all encapsulated and represented as a JDBC data source object.

A database administrator or other authorized user may type the connection information, database names and URLs into a list such as ‘resources.xml,’ and store the list with an application server container. Now the connections needed by applications on the application server are available in object-oriented terms. Each application server starts empty, and part of its configuration process is to examine the list and create one or more pools of connections as described in the list. When an application starts on the application server, the application requests from the application server a reference to a connection pool.

As among containers, servers, applications, and all the other objects, programs, and services that may be running on an application server, it is the pool itself typically that carries out most administrative tasks regarding connections. In the example of FIG. 4, each application server maintains a pool (452, 454, 456) of connections, and, upon notification of a failure of a database, the pool may replace each connection to the failing database with a connection to a replica of the failing database. If no connection to the replica is available in the pool, the pool will request (458) a new connection to the replica. Because each application server only has a network address for the proxy as the network address for each database, all requests for database connections, including requests for connections to replicas, are directed to the network address for the proxy, single call point (460).

In providing connections between the application servers and the databases, highly available connection proxy (409) may assign one or more aliases for each database name that identify more than one database and provide from the proxy to the application server the aliases for identification of the databases. Consider an example or explanation: In an enterprise, the Internet Sales department has a database named ‘Sales.’ In the same enterprise, the Catalog Sales department has a database named ‘Sales.’ Now according to embodiments of this invention, application servers are to be provided the same single point of contact, the same URL or network address for each database connection. Now both databases are to be included in the overall enterprise system represented in FIG. 4. If the single call point (460) were http:\\www.HAconnectionProxy.net, then the combination of the URL and the database names for these two databases would both be Sales, http:\\www.HAconnectionProxy.net. That is, connection requests to these two databases would be ambiguous, no way to tell which is being requested. Assigning aliases allows the Sales database for the Catalog department to be aliased as ‘catalogSales’ and the Sales database for the Internet Sales department to be aliases as ‘internetSales.’

Assigning aliases for database names may be carried out through a table such as the one illustrated at reference (462) on FIG. 4, a table with three columns, one for database names (464), one for aliases (466), and one for the call points or URLs for the databases. Each record in such a table associates one alias with one database name and the call point or URL for the database. When highly available connection proxy (409) receives a connection request for a connection to a database, the request includes the alias for the database based upon the single call point for the highly available connection proxy (409). Remember that in this example, the call points for the databases are not provided to the application servers. Highly available connection proxy (409) upon receiving a connection request may then lookup the call point or URL (468) for the database in table (462) based upon the alias and provide a connection, not between the requesting application server and the highly available connection proxy, but between the requesting application server and the database itself. All the objects (416, 418, 419, 420) provided by highly available connection proxy (409) in this example are actual connections, not wrapper, between application servers and databases. In this way, database commands, Create, Read, Update, Delete, and the like, are communicated (303) directly from an application server to a connected database.

Highly available connection proxy (409) monitors (302) connected databases for database failures. Methods of monitoring connected databases for database failure include:
Implementing Structured Query Language (‘SQL’) heartbeat signals with a simple SQL request that is quickly and easily satisfied by any healthy database, for example, a request for table metadata, requiring no modification to a database;
installing a software agent in DBMS to monitor by periodically reporting on health or just to provide a heartbeat signal back to the proxy—if no heartbeat is received during a predefined period, that is taken as a database failure;
using a TCP/IP ping on a TCP port of a database's DBMS to continually confirm the underlying network connection—take a lack of response to the ping to indicate a database failure;
monitoring database statistics for indications of speed, or rather the lack of speed, in responding to requests—measures of speed lower than a predetermined threshold are taken as database failures; and
monitoring machine statistics of the computer on which the database is installed—if cpu usage declines below a predetermined threshold for a predetermined period of time, indicating input/output binding to the disk drive, for example, take this as an indication of database failure.

Note that some methods of monitoring connected databases for database failure will indicate failures less than total, taken as a measure crossing a threshold, for example. One of the benefits of maintaining connections between application servers and databases in a multitier computer architecture according to embodiments of the present invention is that failures less than total may be detected and acted upon before any application encounters a complete failure. Hence the careful use of the word failure in this specification to include failures less than ‘down’ or ‘unavailable.’ Monitoring for database failure in systems that maintain connections between application servers and databases in a multitier computer architecture according to embodiments of the present invention includes checking health in a broader sense than a complete breakdown. ‘Failure’ as the term is used here can include detecting that a database is presently unavailable because its machine is experiencing a planned reboot—as opposed to an unplanned defect.

Upon detecting a failing database, highly available connection proxy (409) is programmed to replace a connection to a failing database with a connection to a replica of the failing database. In the example of FIG. 4, database (422) is taken as an example of a failing database, connection (416) represents a connection to the failing database that is replace with a connection (418) to a replica (426) of the failing database. Replacing a connection in this context means replacing at least one, probably more than one. Each application server may maintain more than one connection to the failing database, and more than one application server may have connections to the failing database. Highly available connection proxy (409) in this example maintains a list (not shown) of all connections and the application servers or pools to which the connections were issued. Upon detecting a failing database, highly available connection proxy (409) notifies all application servers having connections to the failing database. When it is notified of the failing database, each application server will terminate its pooled connections to the failing database and replace them with connections to the replica. If no connection to the replica is available in an application server or in its connection pool, the pool will request a new connection to the replica.

When providing connections, highly available connection proxy (409) returns each connection from the proxy to an application server that requested the connection and retains in the proxy a callback reference (434) to each connection. Replacing a connection is carried out by the proxy's notifying an application server (or a pool in the application server) of the failing database through the callback reference to the connection to the failing database. In this example, each connection is implemented as an instance or ‘object’ of a connection class, and each callback reference is an object-oriented pointer to a particular connection object. Each connection object is provided with a member method for effecting notifications of a failure of the database connected to an application server by each connection object.

The member method may itself be programmed so that when it is called, it notifies the pool of the database failure. Alternatively, the application server or the pool itself may be registered as a listener for calls to the member method, interpreting any call to the member method as a notification of failure of the database connected by the connection object. Interestingly, if the pool registers as a listener to calls to the callback reference member method, the member method can be completely empty, containing no computer program instructions whatsoever, because it is the mere fact that the member method is called at all that represents notification of a database failure. Either way, all the highly available connection proxy (409) has to do to notify an application server or the appropriate pool of a failing database through the callback reference to the connection to the failing database is simply call the member method through the callback reference, as in:
aCallbackReference.databaseFailureNotification( );

This Java-style computer program instruction represents a call to a member named ‘databaseFailureNotification’ in a callback reference named ‘aCallbackReference.’ The proxy may maintain a list or table of databases and connections to databases so that upon detecting a failure, the proxy can read from the list callback references to all connections to the failing database and then replace them all through calls to callback reference member methods. As mentioned, there may be multiple connections to the failing database, not just one. In addition to replacing the connection and possibly requesting a new one from the proxy, the callback reference member method or the pool itself may also flag the failure or take some other action to for example to notify database administrators or other user of the failure.

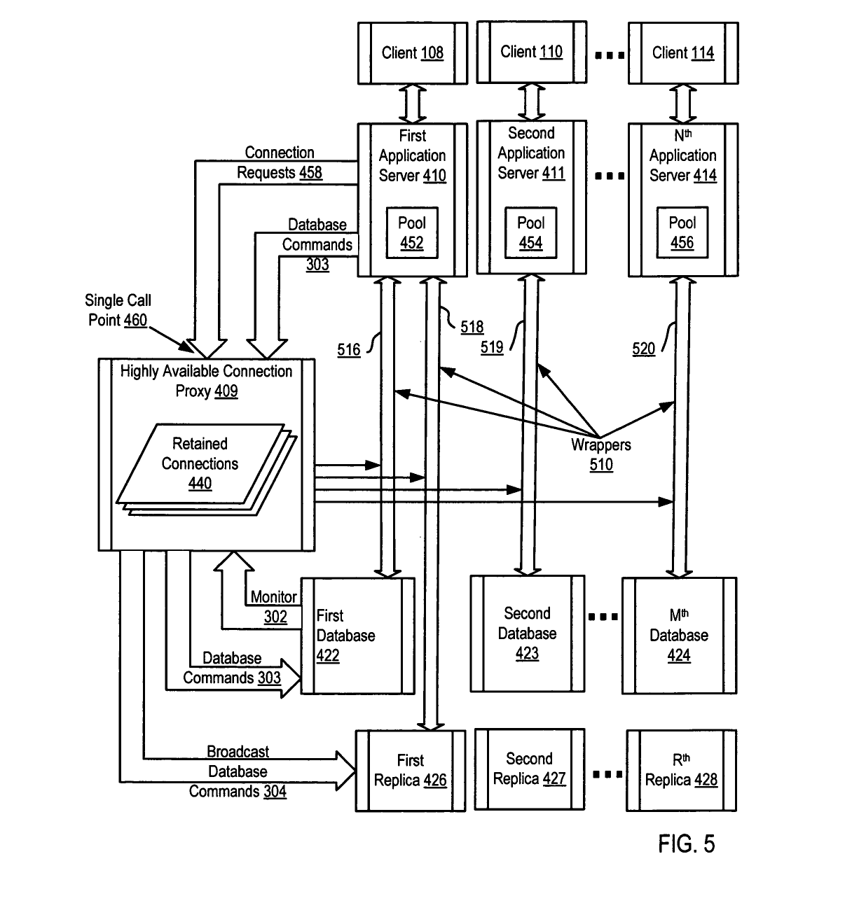

For further explanation, FIG. 5 sets forth a functional block diagram of a further exemplary system for maintaining connections between application servers and databases in a multitier computer architecture according to embodiments of the present invention. The system of FIG. 5 is similar in structure to the system of FIG. 4. The system of FIG. 5, like the system of FIG. 4, includes several client devices (108, 110, 114), the exact number of which is not specified. The system of FIG. 5 also includes N application servers (410, 411, 414), where N can be any number. The system of FIG. 5 also includes M databases (422, 423, 424), where M can be any number. The system of FIG. 5 also includes R replicas (426, 427, 428) of the databases (422, 423, 424), where R can be any number. In the system of FIG. 5, like the system of FIG. 4, highly available connection proxy (409) implements a single call point (460) for providing connections between databases and application servers. Highly available connection proxy (409) monitors (302) connected databases for database failures. Upon detecting a failing database, highly available connection proxy (409) is programmed to replace a connection to a failing database with a connection to a replica of the failing database.

In the system of FIG. 5, however, highly available connection proxy (409) in the process of providing connections to databases does not return the connections to the requesting application servers or pools and retain callback references. Instead, highly available connection proxy (409) in providing connections to databases retains the connections (440) in the proxy and provides to the requesting application server wrappers (510) for the connections retained on the proxy. All objects (416, 419, 420) returned to application server (or to connection pools in application servers) in the example of FIG. 5, are wrappers for connections, not the connections themselves. Objects pooled in connection pools (452, 454, 456) are wrappers for connections rather than the connections themselves. The wrappers represent the connections in the application servers and in connection pools in the application servers.

In the example of FIG. 5, because the connections are retained in the proxy rather than the application server, replacing a connection may be carried out by replacing the connection in the proxy. In the example of FIG. 5, if database (422) is taken to represent a failing database, then the connection (516) to the failing database is replaced with a connection (518) to a replica of the failing database. In this example, however, object (516) and object (518) are both references to the same wrapper. The wrapper's underlying connection has been redirected from the failing database (422) to the replica (426) by replacing in the wrapper a reference to a connection to the failing database with a reference to a connection to the replica. The application server (410) continues to operate using the same wrapper, completely unaware that any failure or change has occurred. Such replacing of a connection in the proxy may be completely transparent the application server, which typically will have no notification of the failure of a database or the replacement of its connection with a connection to a replica. Moreover, applications running on the application server also will suffer no interruptions or exceptions, also simply having no idea that any failure ever occurred.

In the example of FIG. 4, because the application servers had in their possession the actual connections to databases, database commands were issued directly from the application servers to the databases (reference 303 on FIG. 4). Also in the example system of FIG. 4, each replica was maintained as a replica of an operating database by traditional mirroring/journaling/backup technology. In the example of FIG. 5, however, because the connections are retained in the proxy rather than the application server, all database commands (303 on FIG. 5) flow through the proxy (409). Also in the example of FIG. 5, because the connections are retained in the proxy rather than the application server, highly available connection proxy (409) may broadcast (304) all database commands from application servers to replica databases, thereby maintaining the replicas in synchronization with original operating databases and eliminating the need for traditional mirroring or journaling to backup the original operating databases in their replicas.

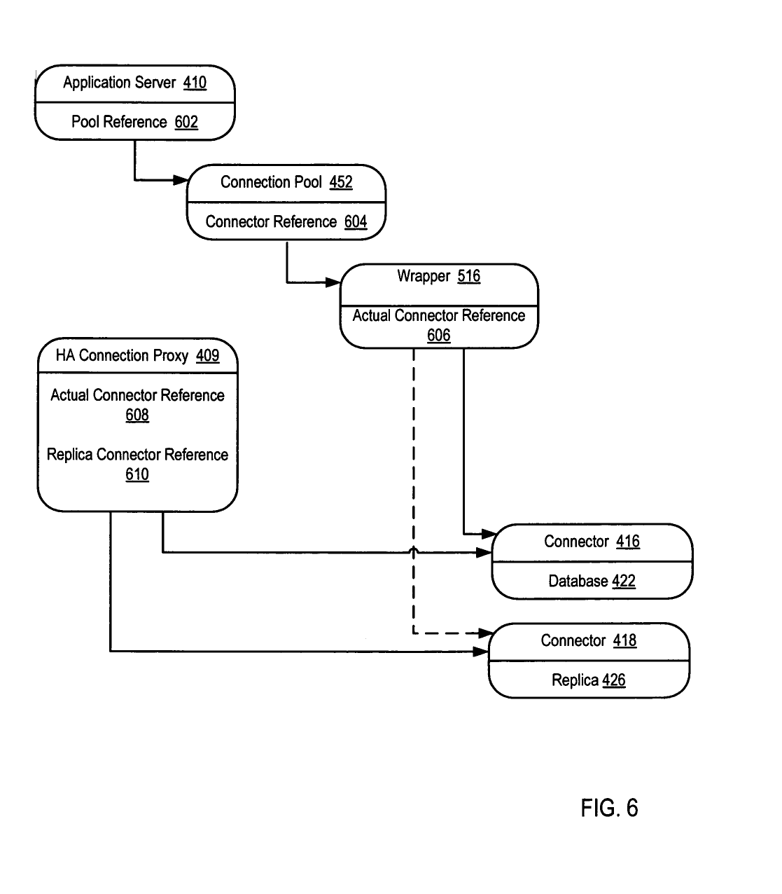

For further explanation, FIG. 6 sets forth a class relationship diagram illustrating an exemplary wrapper for a connection useful in maintaining connections between application servers and databases in a multitier computer architecture according to embodiments of the present invention. In the example of FIG. 6, application server class (410) has a reference (602) to a connection pool class (452). The connection pool class (452) has a reference (604) (typically multiple references) to a wrapper (516) for a connection. Reference (604) appears to the pool and therefore to the application server as a connection because the wrapper is the same data type as the connection and the wrapper presents the same public interface as the connection. The wrapper class (516) has a reference (606) to the actual connector class (416) wrapped by the wrapper. The difference in operation between the wrapper's interface and the connector's interface is that public member methods in the wrapper for ‘CRUD,’ Create, Read, Update, Delete, SQL commands, and the like, call corresponding member methods in the actual connector (416) wrapped by the wrapper. Such calls are polymorphic calls supported by the wrapper's possession of a reference to the actual connector.

A highly available connection proxy (409) for maintaining connections between application servers and databases in a multitier computer architecture according to embodiments of the present invention may maintain a list of connectors (608) to databases, connectors (610) to corresponding replicas, and references to wrappers (516) that have been supplied to application servers or pools in application servers to represent connections to databases. Then, when a failing database is detected, such a highly available connection proxy (409) may replace the connection (416) to a failing database (422) with a connection (418) to a replica (426) of the failing database by retrieving from the list a reference to the wrapper and replacing the reference (608) in the wrapper (516) to the actual connection (416) to the failing database with a reference to a connection (418) to the replica. All of which can be done without ever notifying the application server or the pool in the application server and without interrupting or throwing an exception in operation of any application on the application server.

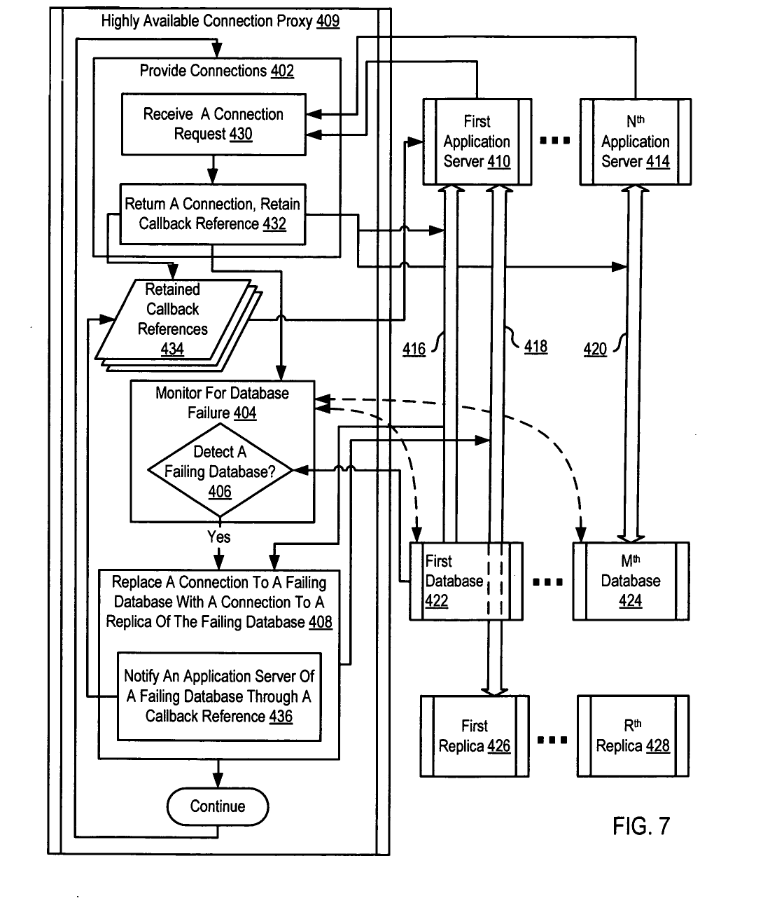

For further explanation, FIG. 7 sets forth a flow chart illustrating an exemplary method for maintaining connections between application servers and databases in a multitier computer architecture according to embodiments of the present invention that includes providing (402), through a highly available connection proxy (409), connections (416, 420) between application servers (410-414) and databases (422-424). The highly available connection proxy (409) implements a single call point (460 on FIG. 4) for providing the connections. The method of FIG. 7 includes monitoring (404) by the highly available connection proxy connected databases for database failures. The method of FIG. 7 also includes replacing (408) by the highly available connection proxy a connection (416) to a failing database (422) with a connection (418) to a replica (426) of the failing database. In the method of FIG. 7, providing connections (402) includes returning (432) each connection from the proxy to the application server that requested (430) the connection while retaining in the proxy a callback reference (434) to each connection. In the method of FIG. 7, replacing a connection includes the proxy's notifying (436) the application server of the failing database through the callback reference to the connection to the failing database.

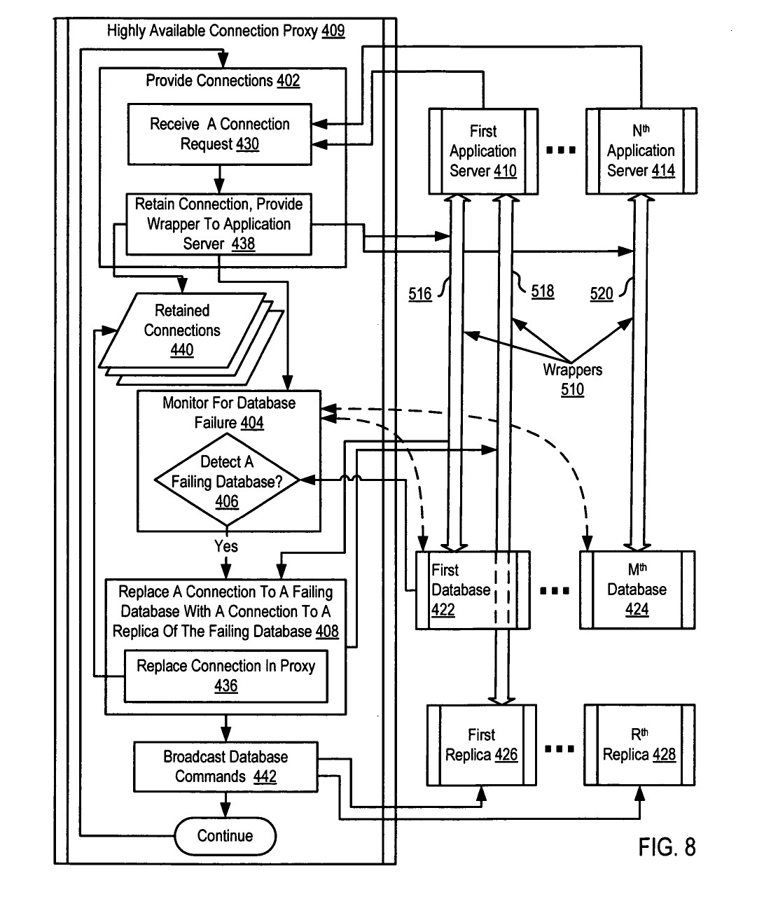

For further explanation, FIG. 8 sets forth a flow chart illustrating a further exemplary method for maintaining connections between application servers and databases in a multitier computer architecture according to embodiments of the present invention. The method of FIG. 8, similar to the method of FIG. 7, includes providing (402), through a highly available connection proxy (409), connections (416, 420) between application servers (410-414) and databases (422-424). The highly available connection proxy (409) implements a single call point (460 on FIG. 5) for providing the connections. The method of FIG. 8 includes monitoring (404) by the highly available connection proxy connected databases for database failures. The method of FIG. 8 also includes replacing (408) by the highly available connection proxy a connection (416) to a failing database (422) with a connection (418) to a replica (426) of the failing database.

In the method of FIG. 8, however, unlike the method of FIG. 7, providing connections (402) includes retaining (438) the connections (440) in the proxy while providing to the application servers (410-414) wrappers (516, 520) for the connections (440) retained on the proxy. The wrappers represent the connections in the application servers. The application servers use the wrappers as though they were direct connections to the databases—which is in fact how they appear to the application servers. The wrappers transparently represent the database connections in the application servers, so that the application servers and their connection pools are unaware of the intervening connection layer in the proxy. In the J2EE example, the proxy proxies a JDBC service, so that the application servers and their pools believe they are requesting and receiving JDBC connections.

In the method of FIG. 8, replacing (408) a connection is carried out by replacing (436) a connection (440) in the proxy. In the method of FIG. 8, the proxy keeps the connections, returning to the application servers wrappers for connections each of which points to the proxy as its database so that all database command traffic and SQL commands are in effect ‘multiplexed’ through the proxy to the underlying databases and replicas. The application servers traditionally would have been deployed with database names and URLs for each database and replica that needs a connection. In the example of FIG. 8, however, the application servers are deployed in the method of FIG. 8 with database names each of which is now associated with a single URL that points to the proxy. The proxy, by retaining connections in the proxy, in effect maintains its own ‘pool’ of underlying connections, creates a wrapper for each connection, and passes the wrappers as object references back to the application servers in response to requests for connections. Then when an application calls a member method in the wrapper, the application is in fact calling that member method in the connection wrapped by the wrapper back on the proxy and therefore in the database or replica itself. In this way, when the proxy detects (406) a database failure, the proxy just replaces (436) the reference in the wrapper (516) to the connection with a reference to a new connection to a replica database.

In the example of FIG. 8, if database (422) is taken to represent a failing database, then the connection (516) to the failing database is replaced with a connection (518) to a replica (426) of the failing database. In this example, however, object (516) and object (518) are both references to the same wrapper. The wrapper's underlying connection has been redirected from the failing database (422) to the replica (426) by replacing in the wrapper a reference to a connection to the failing database with a reference to a connection to the replica. The application server (410) continues to operate using the same wrapper, completely unaware that any failure or change has occurred.

The method of FIG. 8 also includes broadcasting (442) database commands from the application servers (410-414) through the proxy (409) to replica databases (426-428). In the method of FIG. 8, the connections, all connections, both to the active original databases and to the replicas are retained in the proxy. The public member methods for database access in the connection classes may be reprogrammed according to embodiments of the present invention therefore to affect not only the database connected by a connection object, but also to all replicas of that database. As among the CRUD methods, Create, Read, Update, and Delete, only the Create, Update, and Delete methods need such improvement. The Read can always be had against the connected database only because it has no effect on the status or structure of the database and therefore needs no replication.

Exemplary embodiments of the present invention are described largely in the context of a fully functional computer system for maintaining connections between application servers and databases in a multitier computer architecture. Readers of skill in the art will recognize, however, that the present invention also may be embodied in a computer program product disposed on signal bearing media for use with any suitable data processing system. Such signal bearing media may be transmission media or recordable media for machine-readable information, including magnetic media, optical media, or other suitable media. Examples of recordable media include magnetic disks in hard drives or diskettes, compact disks for optical drives, magnetic tape, and others as will occur to those of skill in the art. Examples of transmission media include telephone networks for voice communications and digital data communications networks such as, for example, Ethernets™ and networks that communicate with the Internet Protocol and the World Wide Web. Persons skilled in the art will immediately recognize that any computer system having suitable programming means will be capable of executing the steps of the method of the invention as embodied in a program product. Persons skilled in the art will recognize immediately that, although some of the exemplary embodiments described in this specification are oriented to software installed and executing on computer hardware, nevertheless, alternative embodiments implemented as firmware or as hardware are well within the scope of the present invention.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A method for maintaining connections between application servers and databases in a multitier computer architecture, the method comprising:
providing, through a highly available connection proxy, connections between application servers and databases, the highly available connection proxy implementing a single call point for providing the connections;
monitoring by the highly available connection proxy connected databases for database failures; and
replacing by the highly available connection proxy a connection to a failing database with a connection to a replica of the failing database.

2. The method of claim 1 wherein the highly available connection proxy further comprises a plurality of proxy computers, each communicating its status to the others, and determining by the proxy computers according to an algorithm which proxy computer is to respond to current requests for connections.

3. The method of claim 1 wherein providing connections further comprises listing in the application server a network address for the proxy as the network address for each database.

4. The method of claim 1 wherein providing connections further comprises:
assigning through the proxy one or more aliases for each database name that identifies more than one database; and
providing from the proxy to the application server the aliases for identification of the databases.

5. The method of claim 1 wherein:
providing connections further comprises returning each connection from the proxy to an application server that requested the connection, retaining in the proxy a callback reference to each connection; and
replacing a connection further comprises the proxy's notifying an application server of the failing database through a callback reference to the connection to the failing database.

6. The method of claim 1 wherein:
providing connections further comprises retaining the connections in the proxy, providing to the application servers wrappers for the connections retained on the proxy, the wrappers representing the connections in the application servers;
replacing a connection further comprises replacing a connection in the proxy; and
the method further comprises broadcasting database commands from the application server through the proxy to replica databases.

7. An apparatus for maintaining connections between application servers and databases in a multitier computer architecture, the system comprising a computer processor and a computer memory operatively coupled to the computer processor, the computer memory having disposed within it computer program instructions capable of:
providing, through a highly available connection proxy, connections between application servers and databases, the highly available connection proxy implementing a single call point for providing the connections;
monitoring by the highly available connection proxy connected databases for database failures; and
replacing by the highly available connection proxy a connection to a failing database with a connection to a replica of the failing database.

8. The apparatus of claim 7 wherein the highly available connection proxy further comprises a plurality of proxy computers, each communicating its status to the others, and determining by the proxy computers according to an algorithm which proxy computer is to respond to current requests for connections.

9. The apparatus of claim 7 wherein providing connections further comprises listing in the application server a network address for the proxy as the network address for each database.

10. The apparatus of claim 7 wherein providing connections further comprises:
assigning through the proxy one or more aliases for each database name that identifies more than one database; and
providing from the proxy to the application server the aliases for identification of the databases.

11. The apparatus of claim 7 wherein:
providing connections further comprises returning each connection from the proxy to an application server that requested the connection, retaining in the proxy a callback reference to each connection; and
replacing a connection further comprises the proxy's notifying an application server of the failing database through a callback reference to the connection to the failing database.

12. The apparatus of claim 7 wherein:
providing connections further comprises retaining the connections in the proxy, providing to the application servers wrappers for the connections retained on the proxy, the wrappers representing the connections in the application servers;
replacing a connection further comprises replacing a connection in the proxy; and
the method further comprises broadcasting database commands from the application server through the proxy to replica databases.

13. A computer program product for maintaining connections between application servers and databases in a multitier computer architecture, the computer program product disposed upon a signal bearing medium, the computer program product comprising computer program instructions capable of:
providing, through a highly available connection proxy, connections between application servers and databases, the highly available connection proxy implementing a single call point for providing the connections;
monitoring by the highly available connection proxy connected databases for database failures; and
replacing by the highly available connection proxy a connection to a failing database with a connection to a replica of the failing database.

14. The computer program product of claim 13 wherein the signal bearing medium comprises a recordable medium.

15. The computer program product of claim 13 wherein the signal bearing medium comprises a transmission medium.

16. The computer program product of claim 13 wherein the highly available connection proxy further comprises a plurality of proxy computers, each communicating its status to the others, and determining by the proxy computers according to an algorithm which proxy computer is to respond to current requests for connections.

17. The computer program product of claim 13 wherein providing connections further comprises listing in the application server a network address for the proxy as the network address for each database.

18. The computer program product of claim 13 wherein providing connections further comprises:
assigning through the proxy one or more aliases for each database name that identifies more than one database; and
providing from the proxy to the application server the aliases for identification of the databases.

19. The computer program product of claim 13 wherein:
providing connections further comprises returning each connection from the proxy to an application server that requested the connection, retaining in the proxy a callback reference to each connection; and
replacing a connection further comprises the proxy's notifying an application server of the failing database through a callback reference to the connection to the failing database.

20. The computer program product of claim 13 wherein:
providing connections further comprises retaining the connections in the proxy, providing to the application servers wrappers for the connections retained on the proxy, the wrappers representing the connections in the application servers;
replacing a connection further comprises replacing a connection in the proxy; and
the method further comprises broadcasting database commands from the application server through the proxy to replica databases.
